(19) United States
(12) Patent Application Publication
(10) Pub. No.: US 2026/0134548 A1
(43) Pub. Date: May 14, 2026

(54) TRAINING DIFFUSION NEURAL NETWORKS USING OBJECT REPETITION PRIORS FROM LARGE-SCALE DATASETS

(71) Applicant: Google LLC, Mountain View, CA (US)

(72) Inventors: Matan Yaakov Cohen, Tel Aviv (IL); Daniel Winter, Jerusalem (IL); Asaf Shul, Jerusalem (IL); Alexander Rav Acha, Rehovot (IL); Yael Pritch Knaan, Tel Aviv (IL); Dana Berman, Tel Aviv (IL); Yedid Hoshen, Jerusalem (IL)

(21) Appl. No.: 19/389,933

(22) Filed: Nov. 14, 2025

Related U.S. Application Data
(60) Provisional application No. 63/720,715, filed on Nov. 14, 2024.

(51) Int. Cl. G06T 7/194; G06V 10/82

(52) U.S. Cl. CPC G06T 7/194; G06V 10/82; G06T 2207/20081; G06T 2207/20084

(57) ABSTRACT

Methods, systems, and apparatus, including computer programs encoded on computer storage media, for training a diffusion neural network to perform object insertion or subject-driven image generation on a large-scale, automatically generated training dataset.

### CROSS-REFERENCE TO RELATED APPLICATIONS

This application claims priority to U.S. Provisional Application No. 63/720,715, filed on Nov. 14, 2024. The disclosure of the prior application is considered part of and is incorporated by reference in its entirety in the disclosure of this application.

### BACKGROUND

This specification relates to generating images using neural networks.

Neural networks are machine learning models that employ one or more layers of nonlinear units to predict an output for a received input. Some neural networks are deep neural networks that include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

### SUMMARY

This specification describes a training system implemented as computer programs on one or more computers in one or more locations that trains a diffusion neural network to perform object insertion or subject-driven image generation.

The subject matter described in this specification can be implemented in particular embodiments so as to realize one or more of the following advantages.

The diffusion neural network can perform well on both object insertion and subject-driven image generation at inference time without needing inference-time fine tuning. The diffusion neural network can generate new output from previously unseen input, without having to update values of the parameters of the diffusion neural network after it is trained.

In contrast, many existing, customizable image generation systems require inference-time fine-tuning of a conditional image generation model, e.g., a diffusion neural network, based on one or more images and possibly other data included in an input received by the system. In order to achieve customized image generation conditioned on different inputs received by the system, a fine-tuning process that involves learning fine-tuned values of at least a set of parameters of the image generation model needs to be repeatedly performed.

This fine-tuning process may be required each time a different input is received by the system at inference time, i.e., after the system is deployed. Repeatedly performing this inference-time fine-tuning process is time consuming, and consumes a significant amount of computing resources, e.g., when the system has a large user base that include many users.

Some techniques described in this specification can automatically extract repetition priors—including images that depict common objects with diverse views of different poses and background scenes—from large-scale image datasets in a way that increases the value (e.g., diversity, fidelity, etc.) of the extracted data for training a diffusion neural network. This can, in turn, increase the effectiveness of training of the diffusion neural network. Thus, the amount of computing resources necessary for the training of the diffusion neural network on customizable image generation tasks can be reduced, e.g., measured by reduced processing cycles, reduced memory bandwidth, and/or network bandwidth usage.

By fine-tuning a diffusion neural network prior to deployment using the repetition priors obtained from large-scale image datasets, some described techniques avoid excessive consumption of computing resources by the inference-time fine-tuning that would otherwise need to be repeatedly performed, while still allowing the diffusion neural network to accurately perform object insertion, subject-driven image generation, or another customizable image generation task.

Moreover, because fine-tuning the diffusion neural network each time a new input is received by the system is no longer needed at inference time, the system can use the diffusion neural network to generate new images with reduced latency, e.g., generate new image more quickly in response to user inputs.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1A-B show an example training system.

FIG. 2 is an example illustration of operations performed by the training system to generate a training dataset.

FIG. 3 is a flow diagram of an example process for training a diffusion neural network on an object insertion training dataset.

FIG. 4 is a flow diagram of an example process for training a diffusion neural network on a subject-driven image generation training dataset.

Like reference numbers and designations in the various drawings indicate like elements.

### DETAILED DESCRIPTION

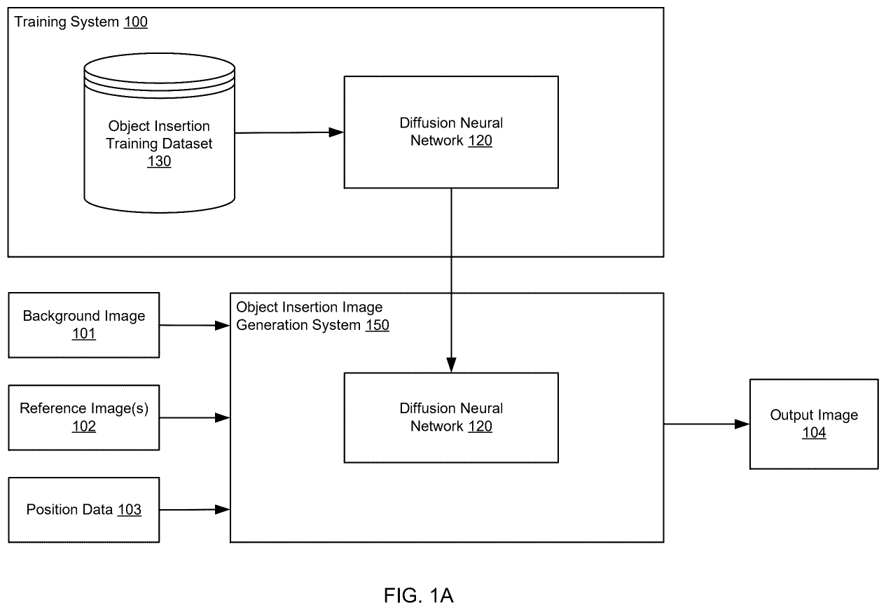

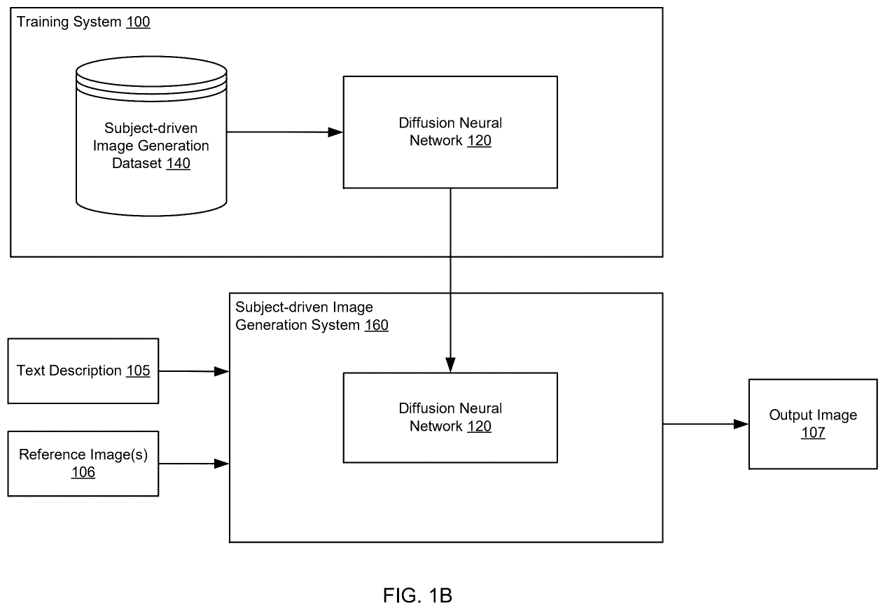

FIG. 1A-B show an example training system 100. The training system 100 is an example of a system implemented as computer programs on one or more computers in one or more locations in which the systems, components, and techniques described below can be implemented.

In some implementations, the training system 100 can train a diffusion neural network 120 to perform object insertion tasks.

Object insertion refers to inserting depictions of objects into background images. The object may be any of a variety of objects including landmarks, landscape or location features, vehicles, tools, food, clothing, devices, animals, humans, to name just a few examples.

FIG. 1A shows the training system 100 in relation to an object insertion image generation system 150. The object insertion image generation system 150 is an example of a system implemented as computer programs on one or more computers in one or more locations in which the diffusion neural network 120 trained by some implementations of the training system 100 can be deployed.

The object insertion image generation system 150 can receive (i) a background image 101, (ii) one or more reference images 102 that each include a depiction of a target object, and (iii) position data 103 defining a target position within an output image, and generate the output image 104 that shares a common scene with the background image 101 and that includes a depiction of the target object at the target location within the output image.

As used herein, an “image” refers to a digital image, such as a two-dimensional image or a three-dimensional image, or even consecutive frames of video. An image can have multiple pixels, where each pixel can have multiple values.

The position data 103 can include a location mask. A “location mask” as described herein refers to a digital representation that includes values that define the target position within an output image.

For example, the location mask can include pixels that define a contour, or boundary, of the target object within the output image.

As another example, the location mask can have the same pixel resolution of the output image, where each pixel can include a value, e.g., a binary value, indicative of the corresponding pixel in the output image being either a foreground pixel (that is part of a depiction of the target object) or a background pixel (that is not part of a depiction of the target object).

The object insertion image generation system 150 can obtain the background image 101 and the one or more reference images 102 in any of a variety of ways.

For example, the object insertion image generation system 150 can receive these images as an upload from a user device over a data communication network, e.g., using an application programming interface (API) made available by the system.

As another example, the object insertion image generation system 150 can receive an input from a device specifying which image that is stored locally at the system or a data store accessible by the system over the data communication network should be used as the background and reference images.

To generate the output image 104, the object insertion image generation system 150 executes a reverse diffusion process using the diffusion neural network 120 conditioned on a conditioning input that includes (i) the background image 101, (ii) the one or more reference images 102, and (iii) the position data 103.

In some implementations, the training system 100 can train a diffusion neural network 120 to perform subject-driven image generation tasks.

Subject-driven image generation refers to generating images that are about a subject that is specified in an input.

A “subject,” as used in this specification, is a characteristic of a scene that is depicted in an image.

For example, a subject can be a specific object that is depicted in the scene. Examples of specific objects include those mentioned above.

As another example, a subject can be rendered text or graphics in the scene.

FIG. 1B shows the training system 100 in relation to a subject-driven image generation system 160. The subject-driven image generation system 160 is an example of a system implemented as computer programs on one or more computers in one or more locations in which the diffusion neural network 120 trained by some implementations of the training system 100 can be deployed.

The subject-driven image generation system 160 can receive (i) a text description 105 corresponding to a target subject and (ii) one or more reference images 106 that each include a depiction of the target subject, and generate the output image 107 of the target subject in a scene.

The subject-driven image generation system 160 can obtain the one or more reference images 106 in ways similar to or different from how the object insertion image generation system 150 obtains the background and reference images.

To generate the output image 107, the object insertion image generation system 150 executes a reverse diffusion process using the diffusion neural network 120 conditioned on a multi-modal conditioning input that includes (i) the text description 105 and (ii) the one or more reference images 106.

Although being described as separate systems, the object insertion image generation system 150 and the subject-driven image generation system 160 may be the same image generation system that deploys the same instance of the diffusion neural network 120.

That is, in some implementations, the image generation system can use the same diffusion neural network 120 to perform both object insertion and subject-driven image generation tasks, depending on data that is included in the inputs to the system, e.g., whether the data includes position data (for object insertion), or a text prompt (for subject-driven image generation).

Once generated, the output image can be used in any of a variety of ways.

For example, the object insertion image generation system 150 can provide the output image 104 for presentation to a user in an interface on a display device of a computing device, e.g., as a response to the user who provided the background image 101 and/or the one or more reference images 102.

As another example, the object insertion image generation system 150 can provide the output image 104 to another system for further processing.

As another example, the object insertion image generation system 150 can store the output image 104 in a repository for later use.

The diffusion neural network 120 can be any appropriate conditional diffusion neural network, i.e., any diffusion neural network that can be used to generate an output image conditioned on a (possibly multi-modal) conditioning input by executing a reverse diffusion process across a plurality of updating iterations.

At each updating iteration in the reverse diffusion process, the diffusion neural network 120 can be configured to receive a diffusion input that includes a current (noisy) representation of an output image as of the updating iteration and a conditioning input and to process the diffusion input to generate a diffusion output for the updating iteration from which an updated representation of the output image can be derived.

For example, the object insertion image generation system 150 can apply a diffusion sampler to map the diffusion output to the updated representation. There are many appropriate diffusion samplers that can be used to update the intermediate representation. Just as a few examples the system can use the DDPM (Denoising Diffusion Probabilistic Model) sampler, the DDIM (Denoising Diffusion Implicit Model) sampler or another appropriate sampler.

In some implementations, the diffusion input includes one or more composite images. Each composite image is structured as a grid, e.g., a 2×2 grid.

For example, for object insertion, the diffusion input can include a concatenation of a total of three composite images concatenated along the channel axis.

A first composite image includes the current representation of the output image in one of the grid cells, e.g., in the top-left cell of the 2×2 grid, and the one or more reference images 102 at the other grid cells.

A second composite image includes the background image 101 in one of the grid cells, e.g., in the top-left cell of the 2×2 grid, and predetermined values (e.g., zeros) at the other grid cells.

A third composite image includes the location mask in one of the grid cells, e.g., in the top-left cell of the 2×2 grid, and predetermined values (e.g., zeros) at the other grid cells.

As another example, for subject-driven image generation, the diffusion input can include a composite image that includes the current representation of the output image in one of the grid cells, e.g., in the top-left cell of the 2×2 grid, and the one or more reference images 102 at the other grid cells.

Generally, the diffusion input also includes time step data that specifies an amount of noise included in the current (noisy) representation of the output image.

If the updating iteration is the first updating iteration in the reverse diffusion process, the current representation of the output image is the initial representation of the output image.

For example, the object insertion image generation system 150 (or the subject-driven image generation system 160) can initialize the representation of the output image, i.e., can generate the initial representation of the output image, based on sampling each value in the representation from a corresponding noise distribution, e.g., a Gaussian distribution, or a different noise distribution.

For any subsequent updating iteration, the current representation of the output image is the updated representation of the output image that has been generated in the immediately preceding updating iteration.

In some implementations, the diffusion neural network 120 performs a reverse diffusion process in pixel space, so that the data items (“representations”) operated on by the diffusion neural network 120 are images that have values for each pixel that specify color values, e.g., RGB values or another color encoding scheme.

In some implementations, the diffusion neural network 120 performs a reverse diffusion process in latent space, e.g., in a latent space that is lower-dimensional than the pixel space. That is, the data items (“representations”) operated on by the diffusion neural network 120 are latent images and the values for the pixels of the latent images are learned, latent values rather than color values.

In these implementations, the diffusion neural network 120 can include or be associated with an image encoder to encode images into the latent space and a decoder neural network that receives an input that includes a latent representation of an image and decodes the latent representation to reconstruct the image. For example, the encoder and decoder can have been trained jointly on an image reconstruction objective, e.g., a VAE objective, a VQ-GAN objective, or a VQ-VAE objective.

In some implementations, at each updating iteration in the reverse diffusion process, the diffusion neural network 120 directly generates the updated representation of the output image, e.g., the diffusion output for the updating iteration includes the updated representation of the output image.

In some implementations, at each updating iteration in the reverse diffusion process, the diffusion neural network 120 indirectly generates the updated representation of the output image, e.g., the diffusion output for the updating iteration includes a noise term computed by the diffusion neural network 120 for the updating iteration, and the updated representation of the output image can then be generated by removing at least some of the noise from the current representation of the output image in accordance with the noise term.

For example, when the diffusion neural network 120 performs a reverse diffusion process in pixel space, the noise term can be an estimate of the noise, as computed by the diffusion neural network 120, that has been added to the output image to arrive at the current (noisy) representation of the output image.

As another example, when the diffusion neural network 120 performs a reverse diffusion process in latent space, the noise term can be an estimate of the noise, as computed by the diffusion neural network 120, that has been added to a latent representation of the output image to arrive at the current representation of the output image.

The diffusion neural network 120 can generally have any suitable conditional diffusion neural network architecture.

Examples of suitable diffusion neural network architectures include those described in Saharia, Chitwan, et al. Photorealistic text-to-image diffusion models with deep language understanding. Advances in Neural Information Processing Systems 35 (2022): 36479-36494; Jonathan Ho, Ajay Jain, and Pieter Abbeel. Denoising Diffusion Probabilistic Models. arXiv:2006.11239, 2020; and Yang Song and Stefano Ermon. Generative Modeling by Estimating Gradients of the Data Distribution. NeurIPS, 2019; and Zhao, Yang, et al. Mobilediffusion: Instant text-to-image generation on mobile devices. European Conference on Computer Vision. Cham: Springer Nature Switzerland, 2024.

For example, the diffusion neural network 120 can have a convolutional neural network architecture, e.g., a U-Net architecture, that has multiple convolutional layer blocks. In some of these cases, the diffusion neural network 120 can include one or more attention layer blocks interspersed among the convolutional layer blocks, where some or all of the attention blocks can be conditioned on one or more representations of the conditioning input.

As another example, the diffusion neural network 120 can have a Transformer neural network architecture that processes the diffusion input through a set of self-attention layers to generate the diffusion output. In these examples, the diffusion neural network 120 can also include one or more attention blocks that are conditioned on one or more representations of the conditioning input.

Such representations of the conditioning input can be generated in any of a variety of ways.

For example, the diffusion neural network 120 can include or be associated with an image encoder neural network that generates an encoded representation of an image, e.g., a background image, a reference image, or a location mask included in position data. Optionally, the diffusion neural network 120 can include or be associated with a text encoder neural network that generates an encoded representation of a text description.

As a particular example, the diffusion neural network 120 can include an image encoder, a text encoder, a diffusion backbone, and an image decoder. Optionally the diffusion neural network 120 can also include a time index encoder.

The image encoder is configured to receive an input and to process the input to generate as output an encoded representation. The input can be a current representation of an output image, and the output can thus be an encoded representation of the output image. Alternatively, the input can be a background or reference image, and the output can thus be an encoded representation of the background or reference image. Alternatively, the input can be a location mask, and the output can thus be an encoded representation of the location mask.

The text encoder is configured to receive an input that includes a text description and to process the input to generate an encoded representation of the text description.

When included, the time index encoder is configured to receive an input that includes the time step data and to process the input to generate an encoded representation of the time step data.

The diffusion backbone is configured to receive an input that includes the encoded representation(s) of the reference image(s), the encoded representation of the background image (when received), the encoded representation of the location mask (when received), the encoded representation of the text description (when received), and either the time step data (when the time index encoder is not included) or the encoded representation of the time step data (when the time index encoder is included), and to process the input to generate a backbone output.

The image decoder is configured to receive as input the backbone output and to process the input to generate the diffusion output.

Generally, the image encoder, text encoder, diffusion backbone, and image decoder, can each have any suitable neural network architecture, i.e., can have any appropriate number of neural network layers (e.g., 1 layer, 5 layers, or 10 layers) of any appropriate type (e.g., fully-connected layers, attention layers, convolutional layers, etc.) connected in any appropriate configuration (e.g., as a linear sequence of layers, or as a directed graph of layers).

The diffusion backbone of the neural network 120 can be conditioned on the encoded representations in any of a variety of ways.

For example, the diffusion backbone can include one or more cross-attention layers that cross attend into the encoded representations.

As another example, the diffusion backbone can include one or more other types of neural network layers that are conditioned on the encoded representations. Examples of such layers include Feature-wise Linear Modulation (FILM) layers, layers with conditional gated activation functions, and so on.

To train the diffusion neural network 120 to perform object insertion, in some implementations, the training system 100 generates an object insertion training dataset 130, and then trains the diffusion neural network 120 to determine the trained values of the parameters of the diffusion neural network 120 based on optimizing an objective function using the object insertion training dataset 130.

To train the diffusion neural network 120 to perform subject-driven image generation, in some implementations, the training system 100 generates a subject-driven image generation training dataset 140, and then trains the diffusion neural network 120 to determine the trained values of the parameters of the diffusion neural network 120 based on optimizing an objective function (which can be the same as the one used to train the diffusion neural network 120 to perform object insertion) using the subject-driven image generation training dataset 140.

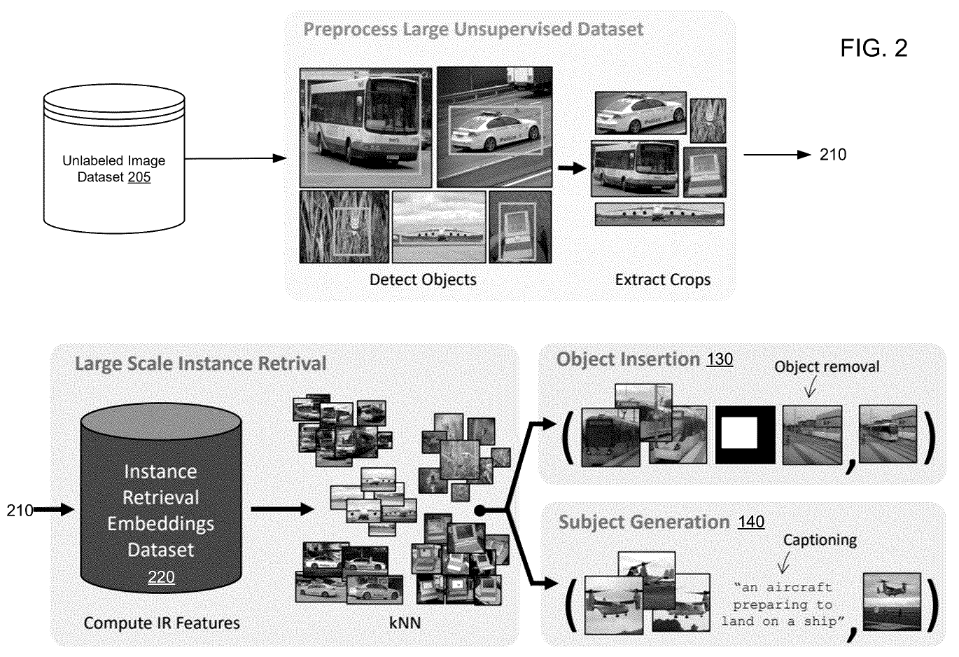

As will be described in more detail below with reference to FIG. 2, the training system 100 generates the object insertion training dataset 130 or the subject-driven image generation training dataset 140 by executing an automated training data generation process in an automatic manner, with no or minimal human involvement, on one or more large-scale, unlabeled image datasets, e.g., an Internet-based image dataset.

The described automated training data generation process overcomes the computation cost and scale limitations faced by a manual training data generation process. For example, the training system 100 can generate a training dataset having images of as many as 4.5 million different objects with reduced processing cycles, reduced memory bandwidth, and/or network bandwidth usage than a training system that relies on a manual training data generation process to generate a comparable training dataset.

The described automated training data generation process also overcomes diversity limitations in the training data faced by existing automated data generation processes that rely on data augmentation. Unlike synthetic data generated through image augmentation or limited video data, which lack diversity in lighting and pose, the described process extracts image data that includes diverse scenes, poses, and lighting conditions from large Internet datasets. It avoids the distributional mismatch that is otherwise common in augmented data.

The distributional mismatch refers to the difference between augmented data and real data. This is a limitation observed in previous approaches, particularly those using single-image augmentations to create synthetic datasets for supervised learning. These synthetic datasets often lack diversity in object poses and lighting conditions compared to the real-world data used for testing.

In some implementations, the training system 100 performs “fine-tuning,” i.e., further training, of the generative neural network 120 to improve the performance of the generative neural network 120 in object insertion or subject-driven image generation or both.

That is, prior to being trained by the training system 100, the training system 100 or another training system has trained the generative neural network 120 on a different objective—and the training system 100 fine-tunes, i.e., further trains, the already-trained generative neural network 120 on the automatically generated training dataset.

In other words, prior to being trained by the system 100, the generative neural network 120 can have been trained conventionally, using any appropriate objective functions, e.g., one or more unsupervised or self-supervised objective functions, on one or more unlabeled or labeled training datasets.

Fine-tuning can be performed until reaching one or more stopping criteria, such as meeting or exceeding a predetermined amount of time since starting to fine-tune, reaching a predetermined number of fine-tuning iterations, not meeting a minimum error improvement between iterations, successive iterations converging within a predetermined threshold of similarity in error, and so on.

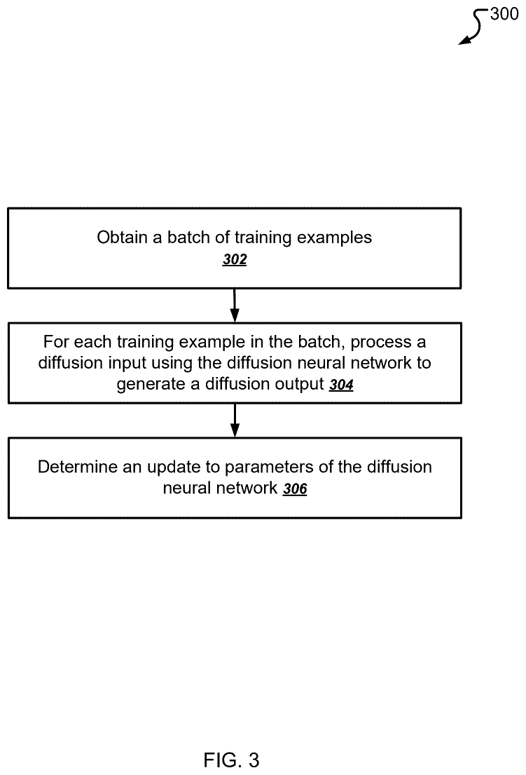

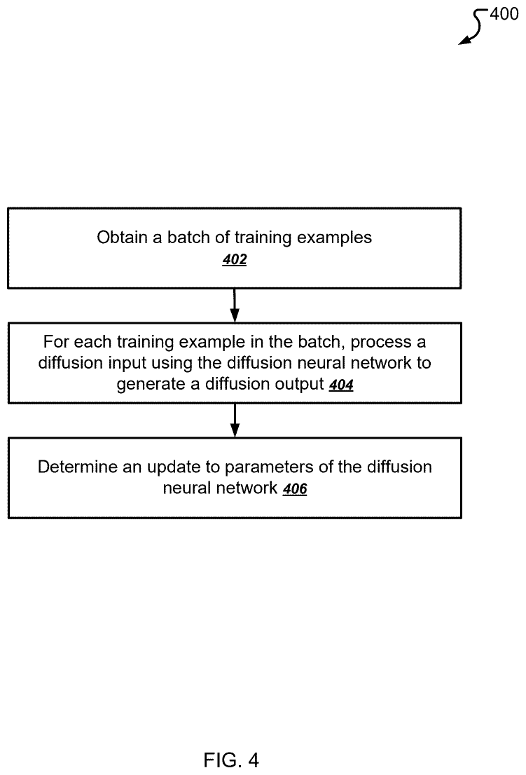

How the training system 100 performs the training, e.g., fine-tuning, will be described in more detail below with reference to FIGS. 3-4.

After the training, the training system 100 system can output data specifying the trained diffusion neural network 120, e.g., parameter data specifying the trained values of the parameters of the diffusion neural network 120 and, optionally, architecture data specifying the architecture of the diffusion neural network 120, to the object insertion image generation system 150 and/or the subject-driven image generation system 160, such that the object insertion image generation system 150 can deploy and use the trained diffusion neural network 120 to insert into background images depictions of new objects that were not seen in the training data for the diffusion neural network 120, and/or that the subject-driven image generation system 160 can deploy and use the trained diffusion neural network 120 to generate new images of new subjects that were not seen in the training data for the diffusion neural network 120.

Training the diffusion neural network 120 on a large-scale training dataset automatically generated by the described automated training data generation process allows the diffusion neural network 120 to avoid repeated fine-tuning at inference time.

Thus, no inference-time fine-tuning is needed in either system 150 or 160 based on the input received by the system in order to generate such an output image. That is, the systems 150, 160 need not adjust the parameters of the diffusion neural network 120 after having received the input, and can directly proceed to use the diffusion neural network 120 to accurately generate the output image based on the input.

This reduces inference-time computation overhead of the systems 150, 160 compared to many existing, customizable image generation systems that rely on inference-time fine-tuning based on the input data.

Such existing systems typically require learning new values for at least a subset of the parameters of a diffusion neural network based on images included a new user input every time the user input is received. Absent the inference-time fine-tuning, an existing system may not be able to generate an output image that shows an accurate depiction of a target object at a target position, or generate an output image that accurately shows the target subject.

FIG. 2 is an example illustration of operations performed by the training system 100 to generate a training dataset based on a large-scale, unlabeled image dataset 205, e.g., an Internet-based image dataset.

The training system 100 extracts a plurality of reference images 210 from the unlabeled image dataset 205. Each reference image depicts an object or a subject.

To extract the plurality of reference images, the training system 100 processes each image in the unlabeled image dataset 205 by using an object detection model to generate an object detection output for the image.

Any machine learning model, e.g., any neural network, such as a convolution neural network or a vision Transformer neural network, that is configured to perform object detection in images can be used. Examples of suitable object detection models include those described in Zhang, Zixiao, et al. ViT-YOLO: Transformer-based YOLO for object detection. Proceedings of the IEEE/CVF international conference on computer vision. 2021, Li, Yanghao, et al. Exploring plain vision transformer backbones for object detection. European conference on computer vision. Cham: Springer Nature Switzerland, 2022, and Ren, Shaoqing, et al. Faster R-CNN: Towards real-time object detection with region proposal networks. IEEE transactions on pattern analysis and machine intelligence 39.6 (2016): 1137-1149.

The object detection output can include bounding box data. The bounding box data can specify the location of each of one or more bounding boxes in the image that depict an object. The bounding box data can represent a bounding box as box coordinates.

The training system 100 then crops the image based on the object detection output, e.g., the bounding box(es), to generate one or more cropped image that each include a depiction of an object. For example, each cropped image can correspond to a region in the image that is enclosed by a bounding box.

In some implementations, the training system 100 directly uses the cropped images as the reference images without further processing. In some other implementations, the training system 100 applies one or more image processing operations on the cropped images to convert the cropped images to the reference images. Examples of these image processing operations include scaling, brightness adjustment, contrast adjustment, and color inversion, among others.

The training system 100 selects, for each of one or more of the plurality of reference images 210, K most similar reference images to the reference image from the plurality of reference images 210. Because each reference image depicts an object or a subject, this is equivalent to determining other reference images that depict a similar object or a similar subject.

To do this, the training system 100 processes each of the plurality of reference images 210 using an image encoder neural network to generate an embedding of the reference image. The generated embedding can be stored in an embedding dataset 220 in association with (i) the reference image, or an identifier that identifies the reference image, and (ii) the original image in the unlabeled image dataset 205 based on which the reference image is generated, or an identifier that identifies the original image.

An embedding, as used in this specification, is an ordered collection of numerical values, e.g., a vector of floating point values or other types of values, e.g., represented as a vector, matrix, or tensor of real continuous numeric values.

Any image encoder neural network, e.g., a convolutional neural network or a vision Transformer neural network, that is configured to map an image to an embedding can be used.

As a particular example, the training system 100 can use an instance retrieval (IR) image encoder neural network that is configured to map an image to an instance retrieval (IR) embedding that represents instance-level features of the object or subject depicted in the image and rather than, e.g., semantic features of the image as represented by a semantic embedding generated by a semantic image encoder neural network, such as an ALIGN encoder.

Examples of suitable instance retrieval (IR) image encoder neural networks include those described in Bingyi Cao, et al. Unifying deep local and global features for image search. In Computer Vision-ECCV 2020: 16th European Conference, Glasgow, UK, Aug. 23-28, 2020, Proceedings, Part XX 16, pages 726-743. Springer, 2020, Shao, Shihao, et al. 1st place solution in google universal images embedding. arXiv preprint arXiv: 2210.08473 (2022), and Nikolaos-Antonios Ypsilantis, et al. Towards universal image embeddings: A large-scale dataset and challenge for generic image representations. In Proceedings of the IEEE/CVF International Conference on Computer Vision, pages 11290-11301, 2023.

The training system 100 perform a k-nearest neighbor (kNN) search computation on the embedding dataset 220 to, for each of one or more of the embeddings stored in the embedding dataset, search for K embeddings that satisfy a similarity criterion with the embedding, e.g., that are most similar to the embedding, according to some similarity measure.

For some similarity measures, e.g., Euclidean distance or other distance measures, the most similar embeddings are those that are closest to the embedding (have the smallest similarity measure with the embedding).

For some other similarity measures, e.g., inner product, the most similar embeddings are those that have the largest similarity measure with the embedding.

K can generally be any positive integer, i.e., any integer greater than or equal to one, but is generally much smaller than the total number N of embeddings in the embedding dataset 220.

Thus, the training system 100 identifies, as the output of the kNN computation, a respective set of k most similar embeddings for each of one or more of the embeddings stored in the embedding dataset. In this way the training system 100 identifies a respective set of k most similar reference images for each of one or more of the plurality of reference images 210.

For each of one or more of the plurality of reference images 210, the training system 100 groups the reference image and the k most similar reference images into a set. Thus, the set includes a plurality of reference images that depict a similar object or subject (and that correspond to a plurality of diverse views of the similar object or subject.

In some implementations, when grouping the reference images into a set, the training system 100 filters out at least one of the reference images selected as a result of the kNN computation based on the similarity measure between the two embeddings.

For example, a similar reference image having an embedding that satisfy a duplicate criterion (which is typically a higher criterion than the similarity according to the same similarity measure) with the embedding of the reference image may be filtered out, i.e., excluded from the set. For example, when the similarity measure is cosine similarity, the similarity criterion can be 0.93, while the duplicate criterion can be 0.98.

This ensures that the objects or subjects depicted in the images included in the same set are exact matches but not near-duplicates of each other, e.g., ensures that the reference images to be grouped together are of the same object instance (“exact matches”) but captured with sufficient diversity in scenes, poses, and lighting conditions to be useful for training, rather than images that are merely slight variations or identical copies (“near-duplicates”).

The training system 100 generates the object insertion training dataset 130. The object insertion training dataset 130 includes a plurality of training examples. Each training example includes (i) a background image, (ii) a target image that includes a depiction of a respective target object at a respective target position within the target image, (iii) a set of one or more reference images of the respective target object, and (iv) position data defining the respective target position within the target image.

To generate a training example for inclusion in the object insertion training dataset 130, the training system 100 uses an original image in the unlabeled image dataset 205 as the target image.

The training system 100 uses, as the set of one or more reference images, one or more of the plurality of reference images included in a set of reference images that includes the reference image generated based on the original image.

The training system 100 processes the original image using an object removal or image inpainting neural network to generate the background image.

Any object removal or image inpainting neural network, e.g., a convolution neural network or a vision Transformer neural network, that is configured to remove a depiction of each of one or more objects (and, in some implementations, their shadows and reflections) from an image can be used. With the depiction of the object(s) moved, the original image is converted to a background image that shows (only) a background scene.

For example, the object removal neural network can be a diffusion object removal neural network, e.g., as described in the Winter, Daniel, et al. Objectdrop: Bootstrapping counterfactuals for photorealistic object removal and insertion. European Conference on Computer Vision. Cham: Springer Nature Switzerland, 2024.

The training system 100 generates the position data based on the bounding box data included in the object detection output generated by the object detection model by processing the original image, e.g., by generating values of the pixels in a location mask based on the coordinates of the bounding box.

Additionally or alternatively, the training system 100 generates the subject-driven image generation training dataset 140. The subject-driven image generation training dataset 140 includes a plurality of training examples. Each training example includes (i) a target image that includes a depiction of a respective target subject, (ii) a set of one or more reference images of the respective target subject, and (iii) a text description corresponding to the respective target subject.

To generate a training example for inclusion in the subject-driven image generation training dataset 140, the training system 100 uses an original image in the unlabeled image dataset 205 as the target image.

The training system 100 uses, as the set of one or more reference images, one or more of the plurality of reference images included in a set of reference images that includes the reference image generated based on the original image.

The training system 100 processes the original image, each of the one or more reference images in the set, or both using an image-to-text neural network to generate the text description.

Any image-to-text neural network, e.g., a vision Transformer neural network, that is configured to process an image to generate a text description or a text caption for the image can be used. The text description (or caption) includes text in some natural language that characterizes the image.

Examples of suitable image-to-text neural networks include those described in Cornia, Marcella, et al. “Meshed-memory transformer for image captioning.” Proceedings of the IEEE/CVF conference on computer vision and pattern recognition. 2020, and Yu, Jun, et al. Multimodal transformer with multi-view visual representation for image captioning. IEEE transactions on circuits and systems for video technology 30.12 (2019): 4467-4480.

In this way the text description generated by the training system 100 can include a text description of a scene in the original image, a text description of an object or subject depicted in the reference image, or both.

In particular, the training system 100 automatically, and with minimal human involvement, generates the background image, the reference images, and the position data for inclusion in a training example in the object insertion training dataset 130 based on using the image encoder neural network, the object detection model, the object removal neural network, and the kNN computation from the large-scale, unlabeled image dataset 205.

The training system 100 automatically, and with minimal human involvement, generates the reference images and the text description for inclusion in a training example in the subject-driven image generation training dataset 140 based on using the image encoder neural network, the object detection model, the image-to-text neural network, and the kNN computation from the large-scale, unlabeled image dataset 205.

FIG. 3 is a flow diagram of an example process 300 for training a diffusion neural network on an object insertion training dataset. For convenience, the process 300 will be described as being performed by a system of one or more computers located in one or more locations. For example, a training system, e.g., the training system 100 of FIG. 1A, appropriately programmed, can perform the process 300.

The object insertion training dataset includes a plurality of training examples. Each training example includes (i) a background image, (ii) a target image that includes a depiction of a respective target object at a respective target position within the target image, (iii) a set of one or more reference images of the respective target object, and (iv) position data defining the respective target position within the target image. The position data can include a location mask.

The system can repeatedly perform iterations of the process 300 on different batches of training examples to update the values of the parameters of the diffusion neural network. The system can continue performing iterations of the process 300 until termination criteria for the training of the diffusion neural network have been satisfied, e.g., until the parameters have converged, until a threshold amount of wall clock time has elapsed, or until a threshold number of iterations of the process 300 have been performed.

The system obtains a batch of training examples from the object insertion training dataset (step 302). The system will generally obtain different training examples at different iterations, e.g., by sampling a fixed number of training examples from a larger number of training examples from the object insertion training dataset at each iteration.

For each training tuple in the batch, the system processes a diffusion input that includes (i) a noisy target image, (ii) the one or more reference images, (iii) the background image, and (iv) the position data using the diffusion neural network to generate a diffusion output that specifies, either directly or indirectly, a predicted target image (step 304).

The noisy target image can be generated by the system based on adding noise to the target image that is included in the training example. The diffusion input can also include time step data that specifies an amount of noise included in the noisy target image.

The system determines an update to the values of the parameters of the diffusion neural network based on optimizing an objective function (step 306). The system can do this by computing, for each training example in the batch, respective gradients of the objective function with respect to the parameters of the diffusion neural network by backpropagation through the appropriate parameters of the diffusion neural network. The system can then determine the updates by applying an update rule, e.g., an Adam update rule, an Rmsprop update rule, or a stochastic gradient descent (SGD) update rule, to the respective gradients.

In some implementations, the values of all of the parameters of the diffusion neural network are updated during the training, whereas, in other implementations, only the values of some of the parameters of the diffusion neural network are updated.

For example, when the diffusion neural network has already been trained on a different training dataset, based on optimizing a different objective function, or both, the system can perform iterations of the process 400 to fine-tune, i.e., further train, the diffusion neural network by updating the values of the parameters of a subset of the layers of the neural network.

For example, the parameters that are being updated can include a set of adaptation parameters, e.g., a set of low rank adaptation (LoRA) parameters, of each of one or more layers of the layers of the diffusion neural network.

The objective function can be any objective function that measures, for each training tuple in the batch, a quality of a diffusion output generated by the diffusion neural network for the training example.

In some implementations where a diffusion output directly specifies a predicted target image, the objective function can be an objective function that measures, for a training example, a difference between (i) the predicted target image included in the diffusion output generated by the generative neural network based on processing a diffusion input and (ii) a target image included in the training example.

In some implementations where each diffusion output includes a noise term computed by the diffusion neural network, the objective function can be an objective function that measures, for a training example, a difference between (i) a noise term generated by the generative neural network based on processing a diffusion input and (ii) a ground truth noise term that defines the actual noise that was added to a target image included in the training example to generate the noisy target image.

As a particular example, the objective function can be a Euclidean diffusion objective function:

$$ℒ ( θ ) = {τ \sim {U ( [ 0 , T ] )}_{ϵ \sim 𝒩 ( 0 , 1 )}}_{} [ {\sum }_{i = 1}^{N} {‖ {D}_{θ} ( {α}_{τ} {y}_{i} + {σ}_{τ} ϵ , {O}_{i} , {S}_{i} , τ ) - ϵ ‖}^{2} ]$$

In this example, D_{θ} represents the diffusion neural network having parameters θ. τ represents the time step data. α_{τ}, σ_{τ} are parameters that define the noise schedule. The system adds the actual noise to a target image y included in a training example in accordance with a noise level that is dependent on this noise schedule. Oᵢ includes the one or more reference images included in the training example. For object insertion, Si includes the background image and the position data included in the training example. N is the batch size (the number of training examples included in the batch).

FIG. 4 is a flow diagram of an example process 400 for training a diffusion neural network on a subject-driven image generation training dataset. For convenience, the process 400 will be described as being performed by a system of one or more computers located in one or more locations. For example, a training system, e.g., the training system 100 of FIG. 1B, appropriately programmed, can perform the process 400.

The subject-driven image generation training dataset includes a plurality of training examples. Each training example includes (i) a target image that includes a depiction of a respective target subject, (ii) a set of one or more reference images of the respective target subject, and (iii) a text description corresponding to the respective target subject. For example, the text description can be a description of the respective target subject, a description of a scene that includes the respective target subject, or both.

The system can repeatedly perform iterations of the process 400 on different batches of training examples to update the values of the parameters of the diffusion neural network. The system can continue performing iterations of the process 400 until termination criteria for the training of the diffusion neural network have been satisfied, e.g., until the parameters have converged, until a threshold amount of wall clock time has elapsed, or until a threshold number of iterations of the process 400 have been performed.

The system a batch of training examples from the subject-driven image generation training dataset (step 402). The system will generally obtain different training examples at different iterations, e.g., by sampling a fixed number of training examples from a larger number of training examples from the subject-driven image generation training dataset at each iteration.

For each training tuple in the batch, the system processes a diffusion input that includes (i) a noisy target image, (ii) the one or more reference images, (iii) the text description using the diffusion neural network to generate a diffusion output that specifies, either directly or indirectly, a predicted target image (step 404).

The noisy target image can be generated by the system based on adding noise to the target image that is included in the training example. The diffusion input can also include time step data that specifies an amount of noise included in the noisy target image.

The system determines an update to the values of the parameters of the diffusion neural network based on optimizing an objective function (step 406). Determining the update to the values of the parameters is similarly described above with reference to step 306 of FIG. 3.

In some implementations, the system uses the same objective function when performing processes 300 and 400 (although the inputs to the objective function may differ). For example, in the Euclidean diffusion objective function described above, for subject-driven image generation, Si includes the text description included in a training example.

While the techniques in this specification are described with respect to generating training data for training diffusion neural networks, more generally the same techniques can be used for generating training data for training any appropriate generative neural network that can map a (possibly multi-modal) conditioning input to an image, e.g., an auto-regressive generative neural network, a non-auto-regressive masked token generation neural network, a normalizing flows model, the generator of a generative adversarial neural network, and so on.

In this specification, the term “configured” is used in relation to computing systems and environments, as well as computer program components. A computing system or environment is considered “configured” to perform specific operations or actions when it possesses the necessary software, firmware, hardware, or a combination thereof, enabling it to carry out those operations or actions during operation. For instance, configuring a system might involve installing a software library with specific algorithms, updating firmware with new instructions for handling data, or adding a hardware component for enhanced processing capabilities. Similarly, one or more computer programs are “configured” to perform particular operations or actions when they contain instructions that, upon execution by a computing device or hardware, cause the device to perform those intended operations or actions.

The embodiments and functional operations described in this specification can be implemented in various forms, including digital electronic circuitry, software, firmware, computer hardware (encompassing the disclosed structures and their structural equivalents), or any combination thereof. The subject matter can be realized as one or more computer programs, essentially modules of computer program instructions encoded on a tangible non-transitory storage medium for execution by or to control the operation of a computing device or hardware. The storage medium can be a storage device such as a hard drive or solid-state drive (SSD), a storage medium, a random or serial access memory device, or a combination of these. Additionally or alternatively, the program instructions can be encoded on a transmitted signal, such as a machine-generated electrical, optical, or electromagnetic signal, designed to carry information for transmission to a receiving device or system for execution by a computing device or hardware. Furthermore, implementations may leverage emerging technologies like quantum computing or neuromorphic computing for specific applications, and may be deployed in distributed or cloud-based environments where components reside on different machines or within a cloud infrastructure.

The term “computing device or hardware” refers to the physical components involved in data processing and encompasses all types of devices and machines used for this purpose. Examples include processors or processing units, computers, multiple processors or computers working together, graphics processing units (GPUs), tensor processing units (TPUs), and specialized processing hardware such as field-programmable gate arrays (FPGAs) or application-specific integrated circuits (ASICs). In addition to hardware, a computing device or hardware may also include code that creates an execution environment for computer programs. This code can take the form of processor firmware, a protocol stack, a database management system, an operating system, or a combination of these elements. Embodiments may particularly benefit from utilizing the parallel processing capabilities of GPUs, in a General-Purpose computing on Graphics Processing Units (GPGPU) context, where code specifically designed for GPU execution, often called kernels or shaders, is employed. Similarly, TPUs excel at running optimized tensor operations crucial for many machine learning algorithms. By leveraging these accelerators and their specialized programming models, the system can achieve significant speedups and efficiency gains for tasks involving artificial intelligence and machine learning, particularly in areas such as computer vision, natural language processing, and robotics.

A computer program, also referred to as software, an application, a module, a script, code, or simply a program, can be written in any programming language, including compiled or interpreted languages, and declarative or procedural languages. It can be deployed in various forms, such as a standalone program, a module, a component, a subroutine, or any other unit suitable for use within a computing environment. A program may or may not correspond to a single file in a file system and can be stored in various ways. This includes being embedded within a file containing other programs or data (e.g., scripts within a markup language document), residing in a dedicated file, or distributed across multiple coordinated files (e.g., files storing modules, subprograms, or code segments). A computer program can be executed on a single computer or across multiple computers, whether located at a single site or distributed across multiple sites and interconnected through a data communication network. The specific implementation of the computer programs may involve a combination of traditional programming languages and specialized languages or libraries designed for GPGPU programming or TPU utilization, depending on the chosen hardware platform and desired performance characteristics.

In this specification, the term “engine” broadly refers to a software-based system, subsystem, or process designed to perform one or more specific functions. An engine is typically implemented as one or more software modules or components installed on one or more computers, which can be located at a single site or distributed across multiple locations. In some instances, one or more dedicated computers may be used for a particular engine, while in other cases, multiple engines may operate concurrently on the same one or more computers. Examples of engine functions within the context of Al and machine learning could include data pre-processing and cleaning, feature engineering and extraction, model training and optimization, inference and prediction generation, and post-processing of results. The specific design and implementation of engines will depend on the overall architecture and the distribution of computational tasks across various hardware components, including CPUs, GPUs, TPUs, and other specialized processors.

The processes and logic flows described in this specification can be executed by one or more programmable computers running one or more computer programs to perform functions by operating on input data and generating output. Additionally, graphics processing units (GPUs) and tensor processing units (TPUs) can be utilized to enable concurrent execution of aspects of these processes and logic flows, significantly accelerating performance. This approach offers significant advantages for computationally intensive tasks often found in AI and machine learning applications, such as matrix multiplications, convolutions, and other operations that exhibit a high degree of parallelism. By leveraging the parallel processing capabilities of GPUs and TPUs, significant speedups and efficiency gains compared to relying solely on CPUs can be achieved. Alternatively or in combination with programmable computers and specialized processors, these processes and logic flows can also be implemented using specialized processing hardware, such as field-programmable gate arrays (FPGAs) or application-specific integrated circuits (ASICs), for even greater performance or energy efficiency in specific use cases.

Computers capable of executing a computer program can be based on general-purpose microprocessors, special-purpose microprocessors, or a combination of both. They can also utilize any other type of central processing unit (CPU). Additionally, graphics processing units (GPUs), tensor processing units (TPUs), and other machine learning accelerators can be employed to enhance performance, particularly for tasks involving artificial intelligence and machine learning. These accelerators often work in conjunction with CPUs, handling specialized computations while the CPU manages overall system operations and other tasks. Typically, a

CPU receives instructions and data from read-only memory (ROM), random access memory (RAM), or both. The elements of a computer include a CPU for executing instructions and one or more memory devices for storing instructions and data. The specific configuration of processing units and memory will depend on factors like the complexity of the AI model, the volume of data being processed, and the desired performance and latency requirements. Embodiments can be implemented on a wide range of computing platforms, from small embedded devices with limited resources to large-scale data center systems with high-performance computing capabilities. The system may include storage devices like hard drives, SSDs, or flash memory for persistent data storage.

Computer-readable media suitable for storing computer program instructions and data encompass all forms of non-volatile memory, media, and memory devices. Examples include semiconductor memory devices such as read-only memory (ROM), solid-state drives (SSDs), and flash memory devices; hard disk drives (HDDs); optical media; and optical discs such as CDs, DVDs, and Blu-ray discs. The specific type of computer-readable media used will depend on factors such as the size of the data, access speed requirements, cost considerations, and the desired level of portability or permanence.

To facilitate user interaction, embodiments of the subject matter described in this specification can be implemented on a computing device equipped with a display device, such as a liquid crystal display (LCD) or an organic light-emitting diode (OLED) display, for presenting information to the user. Input can be provided by the user through various means, including a keyboard), touchscreens, voice commands, gesture recognition, or other input modalities depending on the specific device and application. Additional input methods can include acoustic, speech, or tactile input, while feedback to the user can take the form of visual, auditory, or tactile feedback. Furthermore, computers can interact with users by exchanging documents with a user's device or application. This can involve sending web content or data in response to requests or sending and receiving text messages or other forms of messages through mobile devices or messaging platforms. The selection of input and output modalities will depend on the specific application and the desired form of user interaction.

Machine learning models can be implemented and deployed using machine learning frameworks, such as TensorFlow or JAX. These frameworks offer comprehensive tools and libraries that facilitate the development, training, and deployment of machine learning models.

Embodiments of the subject matter described in this specification can be implemented within a computing system comprising one or more components, depending on the specific application and requirements. These may include a back-end component, such as a back-end server or cloud-based infrastructure; an optional middleware component, such as a middleware server or application programming interface (API), to facilitate communication and data exchange; and a front-end component, such as a client device with a user interface, a web browser, or an app, through which a user can interact with the implemented subject matter. For instance, the described functionality could be implemented solely on a client device (e.g., for on-device machine learning) or deployed as a combination of front-end and back-end components for more complex applications. These components, when present, can be interconnected using any form or medium of digital data communication, such as a communication network like a local area network (LAN) or a wide area network (WAN) including the Internet. The specific system architecture and choice of components will depend on factors such as the scale of the application, the need for real-time processing, data security requirements, and the desired user experience.

The computing system can include clients and servers that may be geographically separated and interact through a communication network. The specific type of network, such as a local area network (LAN), a wide area network (WAN), or the Internet, will depend on the reach and scale of the application. The client-server relationship is established through computer programs running on the respective computers and designed to communicate with each other using appropriate protocols. These protocols may include HTTP, TCP/IP, or other specialized protocols depending on the nature of the data being exchanged and the security requirements of the system. In certain embodiments, a server transmits data or instructions to a user's device, such as a computer, smartphone, or tablet, acting as a client. The client device can then process the received information, display results to the user, and potentially send data or feedback back to the server for further processing or storage. This allows for dynamic interactions between the user and the system, enabling a wide range of applications and functionalities.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more computers, the method comprising:
obtaining an object insertion training dataset that comprises a plurality of training examples, wherein each training example comprises (i) a background image, (ii) a target image that includes a depiction of a respective target object at a respective target position within the target image, (iii) a set of one or more reference images of the respective target object, and (iv) position data defining the respective target position within the target image; and
training a diffusion neural network using the object insertion training dataset, wherein the training comprises:
obtaining a batch of training examples from the object insertion training dataset;
for each training example in the batch, processing a diffusion input that comprises (i) a noisy target image, (ii) the one or more reference images, (iii) the background image, and (iv) the position data using the diffusion neural network to generate a diffusion output that specifies a predicted target image; and
determining an update to parameters of the diffusion neural network based on optimizing an objective function that, for each training example in the batch, measures a quality of the diffusion output generated by the diffusion neural network.

2. The method of claim 1, wherein obtaining the object insertion training dataset comprises:
extracting a plurality of reference images from an unlabeled image dataset, wherein each reference image depicts a target object, and wherein the extracting comprises processing images included in the unlabeled image dataset using an object detection model; and
for each reference image:
performing a search for k most similar reference images to the reference image according to a similarity measure; and
grouping the reference image and the k most similar reference images into a set.

3. The method of claim 2, wherein performing the search for the k most similar reference images to the reference image according to the similarity measure comprises:
processing each of the plurality of reference images using an encoder neural network to generate an embedding of the reference image.

4. The method of claim 3, wherein performing the search for the k most similar reference images to the reference image according to the similarity measure comprises:
for each reference image, performing a search for k most similar embeddings to an embedding of the reference image.

5. The method of claim 1, wherein obtaining the object insertion training dataset comprises:
extracting a plurality of background images from the unlabeled image dataset, wherein each background image includes no depiction of any target object, and wherein the extracting comprises processing the images included in the unlabeled image dataset using an object removal model.

6. The method of claim 1, wherein the diffusion input comprises time step data that specifies an amount of noise included in the noisy target image.

7. The method of claim 1, wherein the objective function comprises a Euclidean diffusion objective function.

8. A system comprising one or more computers and one or more storage devices storing instructions that when executed by the one or more computers cause the one or more computers to perform operations comprising:
obtaining an object insertion training dataset that comprises a plurality of training examples, wherein each training example comprises (i) a background image, (ii) a target image that includes a depiction of a respective target object at a respective target position within the target image, (iii) a set of one or more reference images of the respective target object, and (iv) position data defining the respective target position within the target image; and
training a diffusion neural network using the object insertion training dataset, wherein the training comprises:
obtaining a batch of training examples from the object insertion training dataset;
for each training example in the batch, processing a diffusion input that comprises (i) a noisy target image, (ii) the one or more reference images, (iii) the background image, and (iv) the position data using the diffusion neural network to generate a diffusion output that specifies a predicted target image; and
determining an update to parameters of the diffusion neural network based on optimizing an objective function that, for each training example in the batch, measures a quality of the diffusion output generated by the diffusion neural network.

9. The system of claim 8, wherein obtaining the object insertion training dataset comprises:
extracting a plurality of reference images from an unlabeled image dataset, wherein each reference image depicts a target object, and wherein the extracting comprises processing images included in the unlabeled image dataset using an object detection model; and
for each reference image:
performing a search for k most similar reference images to the reference image according to a similarity measure; and
grouping the reference image and the k most similar reference images into a set.

10. A method performed by one or more computers, the method comprising:
obtaining a subject-driven image generation training dataset that comprises a plurality of training examples, wherein each training example comprises (i) a target image that includes a depiction of a respective target subject, (ii) a set of one or more reference images of the respective target subject, and (iii) a text description; and
training a diffusion neural network using the subject-driven image generation training dataset, wherein the training comprises:
obtaining a batch of training examples from the subject-driven image generation training dataset;
for each training example in the batch, processing a diffusion input that comprises (i) a noisy target image, (ii) the one or more reference images, (iii) the text description using the diffusion neural network to generate a diffusion output that specifies a predicted target image; and
determining an update to parameters of the diffusion neural network based on optimizing an objective function that, for each training example in the batch, measures a quality of the diffusion output generated by the diffusion neural network.

11. The method of claim 10, wherein the text description included in each training example is a description of the respective target subject, a description of a scene that includes the respective target subject, or both.

12. The method of claim 10, wherein obtaining the subject-driven image generation training dataset comprises:
extracting a plurality of reference images from an unlabeled image dataset, wherein each reference image depicts a target subject, and wherein the extracting comprises processing images included in the unlabeled image dataset using an object detection model; and
for each reference image:
performing a search for k most similar reference images to the reference image according to a similarity measure; and
grouping the reference image and the k most similar reference images into a set.

13. The method of claim 12, wherein performing the search for k most similar reference images to the reference image according to the similarity measure comprises:
processing each of the plurality of reference images using an encoder neural network to generate an embedding of the reference image.

14. The method of claim 13, wherein performing the search for k most similar reference images to the reference image according to the similarity measure comprises:
for each reference image, performing a search for k most similar embeddings to an embedding of the reference image.

15. The method of claim 10, wherein obtaining the subject-driven image generation training dataset comprises:
extracting a plurality of target images from the unlabeled image dataset, wherein each background image includes a depiction of a respective target subject.

16. The method of claim 10, wherein the diffusion input also comprises time step data that specifies an amount of noise included in the noisy target image.

17. The method of claim 10, wherein the objective function comprises a Euclidean diffusion objective function.

18. A system comprising one or more computers and one or more storage devices storing instructions that when executed by the one or more computers cause the one or more computers to perform operations comprising:
obtaining an object insertion training dataset that comprises a plurality of training examples, wherein each training example comprises (i) a background image, (ii) a target image that includes a depiction of a respective target object at a respective target position within the target image, (iii) a set of one or more reference images of the respective target object, and (iv) position data defining the respective target position within the target image; and
training a diffusion neural network using the object insertion training dataset, wherein the training comprises:
obtaining a batch of training examples from the object insertion training dataset;
for each training example in the batch, processing a diffusion input that comprises (i) a noisy target image, (ii) the one or more reference images, (iii) the background image, and (iv) the position data using the diffusion neural network to generate a diffusion output that specifies a predicted target image; and
determining an update to parameters of the diffusion neural network based on optimizing an objective function that, for each training example in the batch, measures a quality of the diffusion output generated by the diffusion neural network.

19. The system of claim 18, wherein the text description included in each training example is a description of the respective target subject, a description of a scene that includes the respective target subject, or both.

20. The system of claim 18, wherein obtaining the subject-driven image generation training dataset comprises:
extracting a plurality of reference images from an unlabeled image dataset, wherein each reference image depicts a target subject, and wherein the extracting comprises processing images included in the unlabeled image dataset using an object detection model; and
for each reference image:
performing a search for k most similar reference images to the reference image according to a similarity measure; and
grouping the reference image and the k most similar reference images into a set.
